(19) United States
(12) Patent Application Publication
(10) Pub. No.: US 2019/0001894 A1
(43) Pub. Date: Jan. 3, 2019

(54) REARVIEW MIRROR AND METHOD FOR DRIVING THE SAME

(71) Applicant: BOE Technology Group Co., Ltd., Beijing (CN)

(72) Inventor: Qing DAI, Beijing (CN)

(21) Appl. No.: 15/909,703

(22) Filed: Mar. 1, 2018

(30) Foreign Application Priority Data
Jun. 29, 2017 (CN) 201710518087.5

(51) Int. Cl. B60R 1/08

(52) U.S. Cl. CPC B60R 1/087

(57) ABSTRACT

Disclosed are a rearview mirror and a method for driving the same, and the rearview mirror includes: an optical adjustor, and a control component in a communication connection with the optical adjustor, where the optical adjustor includes a plurality of reflectivity-adjustable windows, where at least one sub-optical adjustors are arranged in each of plurality of reflectivity-adjustable windows; and the control component is configured to control a reflectivity in each of plurality of reflectivity-adjustable windows, so that the rearview mirror can adjust the each of plurality of reflectivity-adjustable windows automatically according to the intensity of light rays incident onto the optical adjustor to thereby control the intensity of the light rays reflected into human eyes.

This application claims the benefit of Chinese Patent Application No. 201710518087.5, filed with the Chinese Patent Office on Jun. 29, 2017, which is hereby incorporated by reference in its entirety.

### FIELD

The disclosure relates to the field of display technologies, and particularly to a rearview mirror and a method for driving the same.

### BACKGROUND

A rearview mirror is such one of necessary components of a vehicle that reflects incident light rays into eyes of a driver to thereby provide the driver with a road condition behind the vehicle. However, strong light of a lamp on a vehicle tailgating may enter the eyes of the driver through the rearview mirror at night, so that there is a blind spot for his or her eyes, thus hindering the driver from driving, and even resulting in his or her blindness, and thus an accident.

In view of this, it is highly desirable in the art to address the technical problem of how to avoid the driver driving at night from suffering from the blind spot arising from strong illumination of the lamp on the vehicle tailgating.

### SUMMARY

An embodiment of the disclosure provides a rearview mirror including: an optical adjustor, and a control component in a communication connection with the optical adjustor, where:

the optical adjustor comprises a plurality of reflectivity-adjustable windows, wherein at least one sub-optical adjustors are arranged in each of the plurality of reflectivity-adjustable windows; and

the control component is configured to control reflectivity in each of the plurality of reflectivity-adjustable windows.

An embodiment of the disclosure further provides a method for driving the rearview mirror above according to the embodiment of the disclosure, the method including:

controlling, by the control component, a reflectivity in each of the plurality of reflectivity-adjustable windows on the optical adjustor.

### BRIEF DESCRIPTION OF THE DRAWINGS

FIG. 1 to FIG. 3 show side views respectively of a rearview mirror according to an embodiment of the disclosure.

FIG. 4 shows a top view corresponding to the side view of the rearview mirror illustrated in FIG. 2.

FIG. 5 is a schematic diagram of a sub-optical adjustor in a window, which is opened through a retractable piece, according to an embodiment of the disclosure.

FIG. 6A to FIG. 6C are schematic diagrams respectively of a sub-optical adjustor in a window, which is rotated around a rotation shaft, according to an embodiment of the disclosure; and

FIG. 7 is a flow chart of a method for driving a rearview mirror according to an embodiment of the disclosure.

### DETAILED DESCRIPTION OF THE EMBODIMENTS

Particular implementations of a rearview mirror and a method for driving the same according to embodiments of the disclosure will be described below in details with reference to the drawings. It shall be noted that the embodiments to be described are only a part but not all of the embodiments of the disclosure. Based upon the embodiments here of the disclosure, all the other embodiments which can occur to those ordinarily skilled in the art without any inventive effort shall fall into the scope of the disclosure as claimed.

In the following implementation, the term, e.g., a controller, etc., can be embodied by a Central Processing Unit (CPU), or can be embodied by a monolithic processor (MCU), a programmable circuit (FPGA), and various other control circuits. The term, e.g., a communication connection, etc., can include a wired electrical connection for transmitting a signal, or a wireless communication connection for transmitting a signal. A micro-electro-mechanical system, also referred to as an MEMS micro-executor, an MEMS motor, etc., includes a micro-actuator for moving a correspondingly connected structure in a number of driving modes (e.g., electrostatic, thermal driving, electromagnetic, mechanical clamping, and other driving modes dependent upon the type of the MEMS driver).

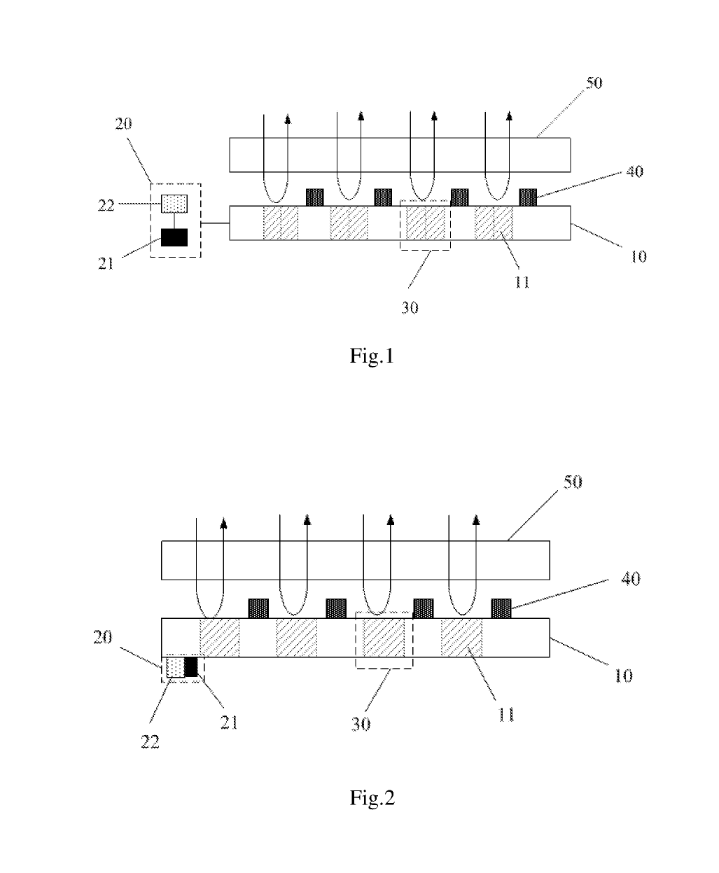

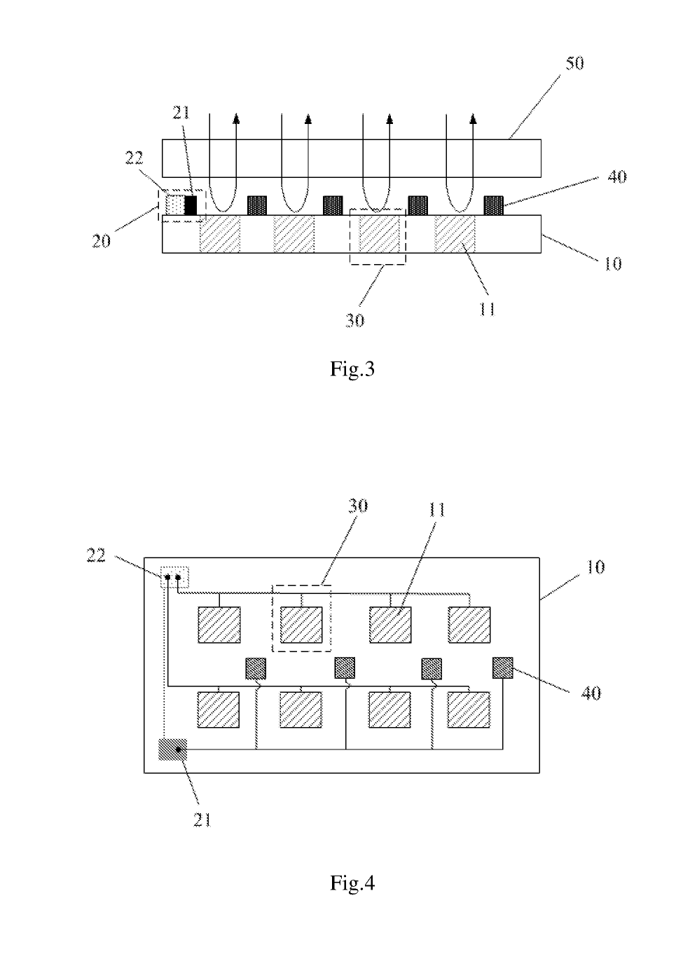

An embodiment of the disclosure provides a rearview mirror as illustrated in FIG. 1 to FIG. 3, which can include an optical adjustor 10, and a control component 20 in a communication connection with the optical adjustor 10, where:

the optical adjustor 10 includes a plurality of reflectivity-adjustable windows 30 (areas denoted in dotted boxes), where at least one sub-optical adjustors 11 (areas filled with slanted lines in the dotted boxes) are arranged in the respective windows; and

the control component 20 is configured to control reflectivities in the respective windows 30.

In the rearview mirror above according to the embodiment of the disclosure, the optical adjustor including the plurality of reflectivity-adjustable windows, and the control component are arranged so that the reflectivities in the respective windows in the the rearview mirror can be adjusted according to the intensity of light rays incident onto the optical adjustor to thereby control the intensity of the light rays reflected into human eyes, and in this way, when the intensity of the light rays illuminating the optical adjustor from the outside is too high or suddenly enhanced, the human eyes can be alleviated from being stimulated by the reflected light rays, to thereby avoid a blind spot from being created, so as to guarantee safe driving.

In some embodiment, the communication connection is a wired or wireless connection to allow a signal to be transmitted and received between components in the communication connection.

In an implementation, the optical adjustor primarily functions to reflect the light rays incident onto the rearview mirror into the human eyes, so the optical adjustor is required to have a high reflectivity in the visible range, that is, there is a reflectivity in such a broad wavelength bandwidth that the optical adjustor can reflect the incident light rays into the human eyes; and hereupon in the rearview mirror above according to the embodiment of the disclosure, the material of the optical adjustor is metal; or there is a metal coating on a first surface of the optical adjustor (i.e., the surface of the optical adjustor receiving the incident light rays). In some embodiment, in order to reflect visible light, the material of the optical adjustor, or the material of the metal coating can be one of or an alloy of aluminum, molybdenum, neodymium, and silver in the rearview mirror above according to the embodiment of the disclosure.

As can be appreciated by those skilled in the art, another plating material, e.g., a nanometer organic polymer coating, a silicon carbide coating, an aluminum magnesium oxide coating, a barium sulfate coating, or another reflecting material available in the chemistry field can also be applicable to the embodiment of the disclosure.

The control component above can be a manual control component, for example, that is, a plurality of reflectivity levels are preset at an interval (for example, a corresponding reflectivity is selected using a button) or a plurality of consecutive reflectivity levels are preset (for example, a corresponding reflectivity is selected using a knob or in a digital control mode). In this case, in order to simplify the design, the control component can be arranged in a central control system of a motored device with a rearview mirror installed therein, e.g., a vehicle, a motorcycle, etc.

In an implementation, in order to detect accurately the intensity of the light rays incident onto the optical adjustor to thereby control the reflectivities in the respective windows, in the rearview mirror above according to the embodiment of the disclosure, as illustrated in FIG. 1 to FIG. 3, the rearview mirror can further include at least one light detector 40 configured to detect the intensity of light rays incident onto the optical adjustor 10, where:

the light detector 40 is arranged in a non-window area on a first surface of the optical adjustor 10; and

the light detection 40 is connected with the control component 20 in communication.

In an embodiment of the disclosure, the number of light detectors may be one, where the light detector is placed at the middle of the non-window area of the optical adjustor to thereby detect accurately the intensity of the incident light rays.

In an embodiment of the disclosure, in order to avoid the intensity of the reflected light rays from being uncontrollable due to the one detector failing to operate, which would otherwise result in a failure of an anti-glare function of the rearview mirror, and further in order to detect the intensity of the light rays more accurately, in the rearview mirror above according to the embodiment of the disclosure, as illustrated in FIG. 1 to FIG. 3, the number of arranged light detectors 40 may be more than one, where:

the respective light detectors 40 are arranged uniformly in the non-window area of the optical adjustor 10 as illustrated in the top view of FIG. 4; where the distribution pattern will not be limited thereto.

In some embodiment, in order to detect the intensity of the light rays reflected to the optical adjustor, in the rearview mirror above according to the embodiment of the disclosure, the light detector is typically a photosensitive diode; and the light detector will not be limited thereto, but may alternatively be another component that can function to detect an intensity of light rays, e.g., a CCD, a CMOS, or another imaging element, although the embodiment of the disclosure will not be limited thereto.

In an implementation, in order to enable the rearview mirror to have a function of display, and an original function of reflecting light, in the rearview mirror above according to the embodiment of the disclosure, as illustrated in FIG. 1 to FIG. 3, the rearview mirror can further include a transparent display screen 50 with a non-display face thereof facing the first surface of the optical adjustor 10, so that the light rays passing the transparent display screen 50 is incident onto the optical adjustor 10, and then reflected by the optical adjustor 10, so the reflected light rays pass the transparent display screen 50 again, and enter the human eyes, and in this way, the function of the rearview mirror is performed.

In some embodiment, the transparent display screen can be a transparent liquid crystal display screen or a transparent electroluminescent display screen, so that when a driver needs to have a view behind his or her vehicle while driving backward, the view can be displayed on the rearview mirror to thereby facilitate driving by the driver so as to improve a driving experience of the driver.

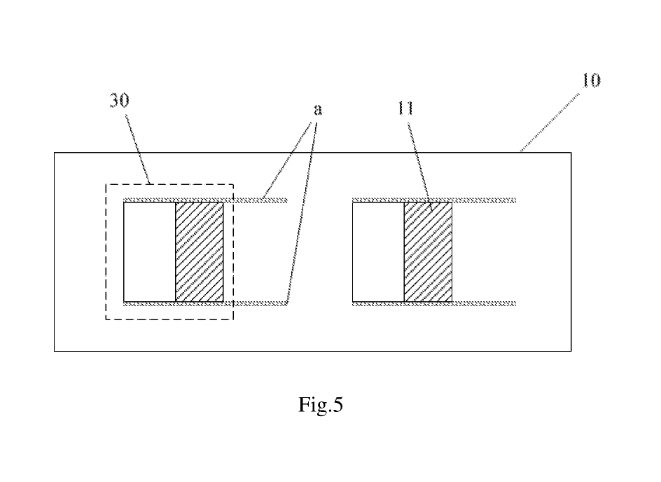

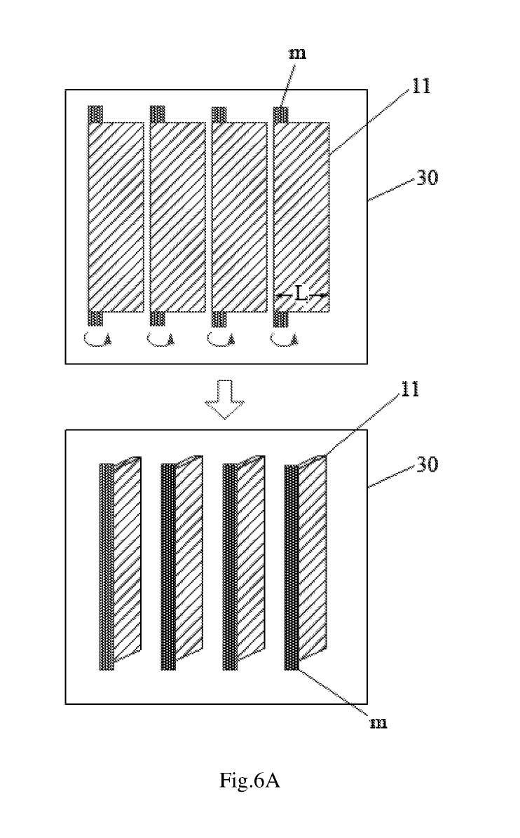

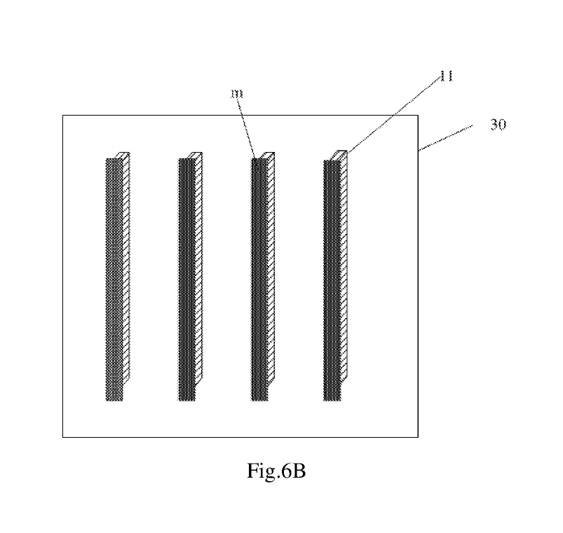

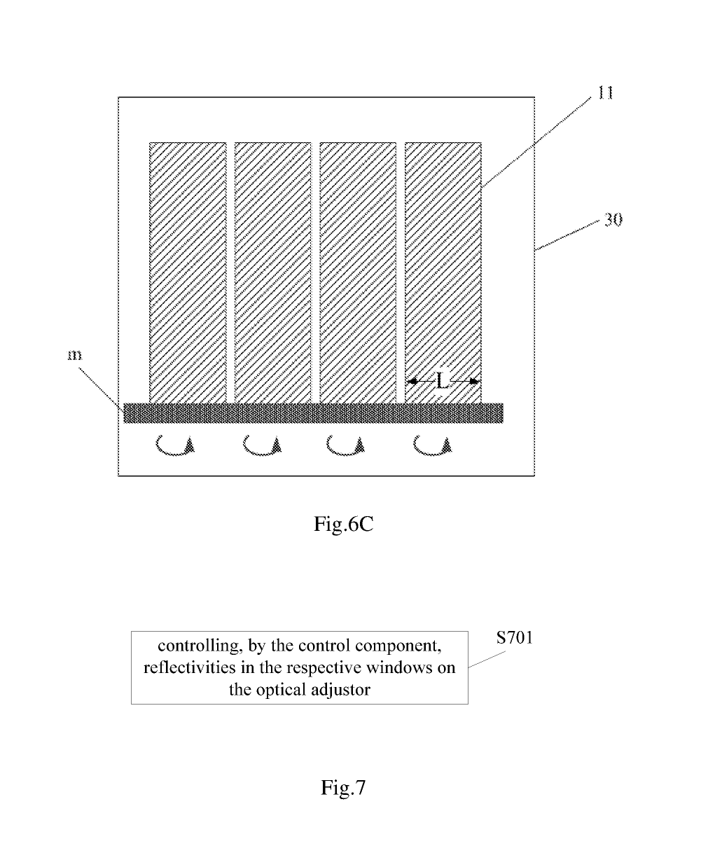

In an implementation, in order to adjust the intensity of the light rays reflected to the transparent display screen, or the eyes of the driver to thereby avoid the human eyes from being simulated by strong light rays, a plurality of reflectivity-adjustable windows are arranged on the optical adjustor. In the rearview mirror above according to the embodiment of the disclosure, in order to adjust the reflectivities in the windows, a sub-optical adjustor 11 can be arranged in each window 30 as illustrated in FIG. 5; and in order to control the reflectivity in the window 30 more finely, and to reduce the overall thickness of the rearview mirror so as to miniaturize the rearview mirror, a plurality of sub-optical adjustors 11 can be arranged in the window 30. Two sub-optical adjustors 11 are arranged in each window 30 as illustrated in the side view of FIG. 1, or four sub-optical adjustors 11 are arranged in each window 30 as illustrated in FIG. 6A to FIG. 6C. When a sub-optical adjustor in the window is opened, the intensity of the light rays incident onto the transparent display screen, or into the eyes of the driver can be lowered, and thus the intensity of the light rays incident onto the transparent display screen, or into the eyes of the driver can be controlled according to the extent to which the sub-optical adjustor is opened.

Particularly in order to adjust the reflectivities in the windows, the sub-optical adjustors 11 can be opened in such a mode that is adjusted using actuators connected in correspondence with the sub-optical adjustors 11. As can be appreciated, there are a number of modes in which the sub-optical adjustors can be opened to change their reflectivities, e.g., a retractable mode and a shutter rotation mode. When the sub-optical adjustors 11 are opened in the shutter rotation mode, in the rearview mirror above according to the embodiment of the disclosure, the sub-optical adjustors 11 in the respective windows are fixed in the windows 30 with their rotation shafts being their actuators; and when there are a plurality of sub-optical adjustors 11 arranged in a window 30, a rotation shaft m is arranged in each sub-optical adjustor 11 as illustrated in FIG. 6A and FIG. 6B, where FIG. 6A illustrates the state of the respective sub-optical adjustors 11 rotated around their rotation shafts m. Alternatively a rotation shaft m can be arranged in the window 30 to control the rotation of the sub-optical adjustors 11 as illustrated in FIG. 6C. In an implementation, a gear or another component can be arranged in the rotation shaft m so that the sub-optical adjustors 11 can be rotated in the direction indicated by the arrow.

In some embodiment, a sub-optical adjustor 11 which can be rotated is generally rotated at an angle from 0 to 90 degrees from the plane the sub-optical adjustor lies. Since the sub-optical adjustor 11 needs to be rotated around the rotation shaft m after it is opened, in order not to affect the overall thickness of the rearview mirror, the width of the sub-optical adjustor 11 in the window can be made as small as possible as illustrated in FIG. 6A and FIG. 6B, where L represents the width of the sub-optical adjustor 11 in the window 30, and generally L can be preset between tens and hundreds of micrometers. A space occupied by each sub-optical adjustor 11 rotated at the largest angle (90 degrees as illustrated in FIG. 6B) can be narrowed to thereby facilitate the miniaturization of the rearview mirror.

In some embodiment, when the sub-optical adjustors are opened in the retractable mode, in the rearview mirror above according to the embodiment of the disclosure, the sub-optical adjustors in the respective windows are arranged in the non-window area with retractable pieces being their actuators, where the retractable pieces arranged on one sides of the sub-optical adjustors, and while the retractable pieces are being retracted, they bring the sub-optical adjustors to be retracted into the non-window area; or retractable pieces “a” can be arranged respectively on both sides of the sub-optical adjustors 11 as illustrated in FIG. 5, where the retractable pieces “a” on both the sides bring together the sub-optical adjustors to be retracted into the non-window area, so that the sub-optical adjustors 11 can be retracted smoothly, thus avoiding the sub-optical adjustors 11 from being deformed due to unequal forces acting on the two sides thereof, which would otherwise degrade the accuracy of controlling the reflectivities thereof.

In an implementation, in order to control the states of the sub-optical adjustors in the windows while detecting the intensity of the light rays incident onto the optical adjustor, in the rearview mirror above according to the embodiment of the disclosure, as illustrated in FIG. 1 to FIG. 3, the control component 20 includes a controller 21 in a communication connection with the light detector 40, and a Micro-Electro-Mechanical System (MEMS) 22 connected respectively with the controller 21, and the retractable pieces of the sub-optical adjustors 11;

where the controller 21 is configured to transmit a corresponding control signal to the MEMS 22 according to the intensity of the light rays detected by the light detector 40; and

when the sub-optical adjustors 11 are opened in the shutter rotation mode, the MEMS 22 is configured to control the rotation angles of the rotation shafts according to the control signal.

In some embodiment, when the sub-optical adjustors 11 are opened in the retractable mode, in the rearview mirror above according to the embodiment of the disclosure, as illustrated in FIG. 1 to FIG. 3, the control component 20 includes a controller 21 in a communication connection with the light detector 40, and a Micro-Electro-Mechanical System (MEMS) 22 connected respectively with the controller 21, and the retractable pieces of the sub-optical adjustors 11;

where the controller 21 is configured to transmit a corresponding control signal to the MEMS 22 according to the intensity of the light rays detected by the light detector 40; and

the MEMS 22 is configured to control the rotation angles of the rotation shafts according to the control signal.

As described above, the controller 21 is in a communication connection with the MEMS 22; and the MEMS 22 operates as a driver fixedly connected (a separable or inseparable manner) with the rotation shafts, the retractable pieces, or the other actuators to thereby bring them into desirable motion.

Particularly since the sub-optical adjustors 11 are opened in a different mode, the MEMS 22 in the control component 2 also controls differently the sub-optical adjustors 11 to be opened. Furthermore the MEMS 22 and the controller 21 in the control component 20 can be arranged on the side of the optical adjustor 10 away from the transparent display screen 50, or the eyes of the driver as illustrated in FIG. 2. As illustrated in the top view of FIG. 4, the MEMS 22 can be connected with the respective retractable pieces or the respective rotation shafts through via-holes in the optical adjustor 10 (black dots illustrated in FIG. 4), and the controller 21 can be in communication connections with the respective light detectors 40 (for example, wires can be threaded through the via-holes in the case that the communication connections are wired connections), where only the positions of the windows 30 are illustrated, but the rotation shafts or the retractable pieces in the windows 30 are not illustrated; or the MEMS 22 and the controller 21 are connected with each other on the side of the optical adjustor 10 away from the transparent display screen 50, or the eyes of the driver.

In some embodiment, in order to increase the number of reflectivity-adjustable windows 30 to thereby control precisely the reflectivities in the windows 30, the control component 20 can alternatively be arranged outside the optical adjustor 10 as illustrated in FIG. 1. The MEMS 22 in the control component 20 are connected with the retractable pieces or the rotation shafts, and the controller 21 is connected with the light detector 40, so that the controller 21 controls the MEMS 22 according to the intensity of the light rays detected by the light detector 40, and thus the MEMS 22 controls the retracting extents of the retractable pieces, or the rotation angles of the rotation shafts to thereby adjust the reflectivities in the windows 30 for the purpose of preventing glare.

In some embodiment, in order to control precisely the sub-optical adjustor in each window, an MEMS can be arranged for each window, and each MEMS can be connected respectively with the controller, so that the controller controls the respective MEMS's respectively to thereby improve the precision of controlling the reflectivity.

In some embodiment, the component configured to transmit the corresponding control signal to the MEMS according to the intensity of the light rays detected by the light detector will not be limited to the controller, and the component configured to control the retracting extents of the retractable pieces, or the rotation angles of the rotation shafts according to the control signal will not be limited to the MEMS, but they can alternatively be other components capable of performing the functions of the MEMS and the controller, although the embodiment of the disclosure will not be limited thereto.

The rearview mirror above according to the embodiment of the disclosure can be applicable to a vehicle, but also can be applicable to a motorcycle, an electric vehicle, or another vehicle for which a rearview mirror is required, to provide it with the anti-glare function, and the function of displaying an image, although the embodiment of the disclosure will not be limited thereto.

Based upon the same inventive idea, an embodiment of the disclosure further provides a method for driving the rearview mirror above according to the embodiment of the disclosure, as illustrated in FIG. 7, where the method can include the following step:

controlling, by the control component, reflectivities in the respective windows on the optical adjustor.

In the driving method above according to the embodiment of the disclosure, the control component can control the reflectivities in the respective windows on the optical adjustor, so that the reflectivities in the respective windows of the rearview mirror can be adjusted automatically according to the intensity of light rays incident onto the optical adjustor to thereby control the intensity of the light rays reflected into human eyes, and in this way, the human eyes can be alleviated from being stimulated by the reflected light rays, to thereby avoid a blind spot from being created, so as to enable the anti-glare function to thereby guarantee safe driving.

In an implementation, in the driving method above according to the embodiment of the disclosure, controlling, by the control component, the reflectivities in the respective windows on the optical adjustor in the step S701 can include:

detecting, by a light detector, an intensity of light rays incident onto the optical adjustor; and

adjusting, by the control component, reflectivities of the sub-optical adjustors in the windows according to the intensity of the light rays detected by the light detector, and a preset correspondence relationship between an intensity of light rays, and a reflectivity.

In some embodiment, as can be readily appreciated, in the driving method above, the correspondence relationship between an intensity of light rays, and a reflectivity is that an intensity of light rays is negatively correlated with a reflectivity, that is, the reflectivity shall be lowered at a higher intensity of light rays. For example, the reflectivity shall be lowered to an extent that reflected light rays will not cause glare, or affect his or her normal vision. However, there may be a low intensity of light rays in some scenario in reality, e.g., at night, or in a tunnel. In view of this, a preset light intensity threshold for light rays incident onto the optical adjustor can be preset in the controller, where the preset light intensity threshold can be preset so that the intensity of the light rays incident onto the optical adjustor will not be so high that the light rays are reflected from the optical adjustor into the eyes of the driver at such an intensity of light rays that results in glare, or that hinders the driver from visually observing normally. The optical adjustor will not be adjusted, that is, the sub-optical adjustors in the windows are maintained as they have been, at or below the preset light intensity threshold, so that all of the incident light rays are reflected to the transparent display screen, or into the eyes of the driver, to enable the driver to see clearly a road condition behind his or her vehicle.

In some embodiment, in the driving method above, the control component can adjust the reflectivities of the sub-optical adjustors in the windows by adjusting rotation angles, of the at least one sub-optical adjustors arranged in the respective windows on the optical adjustor, relative to the optical adjustor.

In the adjustment scheme above, when the intensity of the light rays is above the preset light intensity threshold, the higher the intensity of light rays is, the larger the corresponding rotation angles are, and the lower the reflectivities are, thus avoiding the driver from failing to visually observe normally due to glare of light rays, etc.

In some embodiment, controlling, by the control component, the reflectivities of the sub-optical adjustors in the windows in the driving method above can include:

adjusting retracting extents, of the at least one sub-optical adjustors arranged in the respective windows on the optical adjustor, relative to the windows.

In the adjustment scheme above, when the intensity of the light rays is above the preset light intensity threshold, the higher the intensity of light rays is, the higher the retracting extents of the retractable pieces are, and the lower the reflectivities are, thus avoiding the driver from failing to visually observe normally due to glare of light rays, etc., so as to enable the driver to see clearly a road condition behind his or her vehicle.

The embodiments of the disclosure provide a rearview mirror and a method for driving the same, and the rearview mirror includes: an optical adjustor, and a control component in a communication connection with the optical adjustor, where the optical adjustor includes a plurality of reflectivity-adjustable windows, where at least one sub-optical adjustors are arranged in the respective windows; and the control component is configured to control reflectivities in the respective windows. In the rearview mirror according to the embodiment of the disclosure, the reflectivities in the respective windows in the rearview mirror can be adjusted according to the intensity of light rays incident onto the optical adjustor to thereby control the intensity of the light rays reflected into human eyes, and in this way, when the intensity of the light rays illuminating the optical adjustor from the outside is too high or suddenly enhanced, the human eyes can be alleviated from being stimulated by the reflected light rays, to thereby avoid a blind spot from being created, so as to guarantee safe driving.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A rearview mirror, comprising: an optical adjustor, and a control component in a communication connection with the optical adjustor, wherein:
the optical adjustor comprises a plurality of reflectivity-adjustable windows, wherein at least one sub-optical adjustors are arranged in each of the plurality of reflectivity-adjustable windows; and
the control component is configured to control reflectivity in each of the plurality of reflectivity-adjustable windows.

2. The rearview mirror according to claim 1, further comprises at least one light detector configured to detect an intensity of light rays incident onto the optical adjustor, wherein:
the light detector is arranged in a non-window area of a first surface of the optical adjustor; and
the light detector is in a communication connection with the control component.

3. The rearview mirror according to claim 2, wherein a quantity of light detectors is more than one; and
the respective light detectors are arranged uniformly in the non-window area of the optical adjustor.

4. The rearview mirror according to claim 2, wherein the at least one sub-optical adjustors in each of the plurality of reflectivity-adjustable windows are fixed in the each of the plurality of reflectivity-adjustable windows through an actuator.

5. The rearview mirror according to claim 4, wherein the actuator is a rotation shaft, and the control component comprises: a controller in a communication connection with the light detector, and a Micro-Electro-Mechanical System (MEMS) connected respectively with the controller and the rotation shaft, wherein:
the controller is configured to transmit a corresponding control signal to the MEMS according to the intensity of the light rays detected by the light detector; and
the MEMS is configured to control an rotation angle of the rotation shaft according to the control signal.

6. The rearview mirror according to claim 2, wherein the at least one sub-optical adjustors in each of the plurality of reflectivity-adjustable windows are fixed in the non-window area through an actuator.

7. The rearview mirror according to claim 6, wherein the actuator is a retractable piece, and the control component comprises: a controller in a communication connection with the light detector, and a Micro-Electro-Mechanical System (MEMS) connected respectively with the controller and the retractable pieces, wherein:
the controller is configured to transmit a corresponding control signal to the MEMS according to the intensity of the light rays detected by the light detector; and
the MEMS is configured to control a retracting extent of the retractable piece according to the control signal.

8. The rearview mirror according to claim 1, wherein a material of the optical adjustor is metal; or there is a metal coating on a first surface of the optical adjustor.

9. The rearview mirror according to claim 8, wherein the material of the optical adjustor, or the material of the metal coating can be one of or an alloy of aluminum, molybdenum, neodymium, and silver.

10. The rearview mirror according to claim 1, further comprises: a transparent display screen, wherein a non-display surface of the transparent display screen faces a first surface of the optical adjustor.

11. A method for driving the rearview mirror according to claim 1, the method comprising:
controlling, by the control component, a reflectivity in each of the plurality of reflectivity-adjustable windows on the optical adjustor.

12. The driving method according to claim 11, wherein controlling, by the control component, the reflectivity in each of the plurality of reflectivity-adjustable windows on the optical adjustor comprises:
detecting, by a light detector, an intensity of light rays incident onto the optical adjustor; and
adjusting, by the control component, a reflectivity of the at least one sub-optical adjustors in each of the plurality of reflectivity-adjustable windows according to the intensity of the light rays detected by the light detector, and a preset correspondence relationship between an intensity of light rays, and a reflectivity.

13. The driving method according to claim 12, wherein the correspondence relationship between an intensity of light rays, and a reflectivity is that the intensity of light rays at or above a preset light intensity threshold is negatively correlated with the reflectivity.

14. The driving method according to claim 12, wherein adjusting, by the control component, the reflectivity of the at least one sub-optical adjustors in each of the plurality of reflectivity-adjustable windows comprises:
adjusting an rotation angle, of the at least one sub-optical adjustors arranged in reflectivity of the at least one sub-optical adjustors in each of the plurality of reflectivity-adjustable windows on the optical adjustor, relative to the optical adjustor.

15. The driving method according to claim 12, wherein adjusting, by the control component, the reflectivity of the at least one sub-optical adjustors in each of the plurality of reflectivity-adjustable windows comprises:
adjusting a retracting extent, of the at least one sub-optical adjustors arranged in reflectivity of the at least one sub-optical adjustors in each of the plurality of reflectivity-adjustable windows on the optical adjustor, relative to each of the plurality of reflectivity-adjustable windows.
